(19) United States
(12) Patent Application Publication
(10) Pub. No.: US 2018/0178071 A1
(43) Pub. Date: Jun. 28, 2018

(54) GOLF BALL

(71) Applicant: DUNLOP SPORTS CO. LTD., Kobe-shi (JP)

(72) Inventors: Kazuya KAMINO, Kobe-shi (JP); Hidetaka INOUE, Kobe-shi (JP); Toshiyuki TARAO, Kobe-shi (JP)

(73) Assignee: DUNLOP SPORTS CO. LTD., Kobe-shi (JP)

(21) Appl. No.: 15/786,189

(22) Filed: Oct. 17, 2017

(30) Foreign Application Priority Data
Dec. 22, 2016 (JP) 2016-249293

(51) Int. Cl. A63B 37/00; C08K 3/22; C08K 3/30; C09D 175/08; C09D 163/04

(52) U.S. Cl. CPC A63B 37/0022; C08K 2003/2241; A63B 37/0031; A63B 37/0075; A63B 37/0051; A63B 37/0064; A63B 37/0062; A63B 37/0039; A63B 37/0043; A63B 37/008; A63B 37/0065; A63B 37/0045; A63B 37/0033; A63B 37/0087; A63B 37/0024; A63B 37/0096; C08K 3/22; C08K 3/30; C09D 175/08; C09D 163/04; A63B 37/0053; A63B 37/0073; A63B 37/0076; C08K 2003/2296; C08K 2003/3045; A63B 37/0074

(57) ABSTRACT

A golf ball 2 includes a main body 4 and a paint layer 6 positioned outside the main body 4. The main body 4 includes a spherical core 8, a mid layer 10 positioned outside the core 8, and a cover 12 positioned outside the mid layer 10. The paint layer 6 includes an inner layer 14 and an outer layer 16 positioned outside the inner layer 14. When an indentation depth (nm) is measured on a cross-section along a plane passing through a central point of the golf ball 2 when a force of 30 mgf is applied to the cross-section in a direction perpendicular to the cross-section, an indentation depth Di on a cross-section of the inner layer 14 is lower than an indentation depth Do on a cross-section of the outer layer 16.

This application claims priority on Patent Application No. 2016-249293 filed in JAPAN on Dec. 22, 2016. The entire contents of this Japanese Patent Application are hereby incorporated by reference.

### BACKGROUND OF THE INVENTION

### Field of the Invention

The present invention relates to golf balls. Specifically, the present invention relates to golf balls having a paint layer on the surface thereof.

### Description of the Related Art

Controllability upon approach shots is important for golf players. When a golf ball is hit with a golf club, the golf ball flies with backspin. When the rate of the backspin is high, the run of the golf ball after landing is short. By using a golf ball having a high backspin rate, a golf player can cause the golf ball to stop at a target point. When the rate of sidespin is high, the golf ball tends to curve. By using a golf ball having a high sidespin rate, a golf player can intentionally cause the golf ball to curve. A golf ball to which spin is easily provided has excellent controllability.

In play, a golf ball is hit under various conditions. A golf club or a golf ball may get wet with rain or the like. A state where a golf club or a golf ball is wet is referred to as wet state. On the other hand, a state where a golf club or a golf ball is not wet is referred to as dry state. Golf players desire golf balls that achieve excellent controllability both in a dry state and in a wet state.

Golf players also place importance on feel at impact of golf balls as well as controllability. Many golf players prefer soft feel at impact.

Most golf balls have a paint layer on the surface thereof. The roles of the paint layer are to enhance the appearance of golf balls and prevent staining of golf balls. Furthermore, the paint layer can also contribute to controllability and feel at impact.

Golf balls having a paint layer improved in order to improve various performance characteristics have been proposed. In JP2011-217820 (US2011/0244989 A1), the Martens hardness and the modulus of a paint layer are studied in order to increase the spin rates upon approach shots under a wet condition and under a rough condition.

JP2013-126541 (US2013/0157782 A1), JP2013-126542 (US2013/0157782 A1, US2013/0157784 A1), and JP2013-126543 (US2013/0157782 A1, US2013/0157783 A1) disclose golf balls including a paint layer having a predetermined JIS-C hardness and a Young's modulus. In these golf balls, spin performance is improved by making the paint layer flexible.

In JP2014-14383 (US2013/0331205 A1), the storage modulus and the loss tangent of a paint layer are studied in order to improve controllability upon an approach shot. In JP2016-123632 (US2016/0184654 A1), both desired feel at impact and desired stain resistance are achieved by adjusting the modulus of a paint layer.

Conventionally, a more flexible paint layer is adopted in order to improve spin performance. A flexible paint layer can contribute to controllability and feel at impact in a dry state. However, according to the finding by the present inventors, the spin rate in a wet state of a golf ball in which a flexible paint layer is adopted is not sufficiently high. In addition, there is also room for improvement in stain resistance of the golf ball. Furthermore, since the paint layer is thin, it is difficult to directly measure the physical properties of the paint layer.

The Martens hardness and the modulus disclosed in JP2011-217820 (US2011/0244989 A1) are measured on a slab having the same composition as the composition of the paint layer. The Young's moduli disclosed in JP2013-126541 (US2013/0157782 A1), JP2013-126542 (US2013/0157782 A1, US2013/0157784 A1), and JP2013-126543 (US2013/0157782 A1, US2013/0157783 A1) are measured on a sheet having a thickness of 2 mm. The storage modulus and the loss tangent disclosed in JP2014-14383 (US2013/0331205 A1) are measured on a film having the same composition as the composition of the paint layer. Therefore, these measurement results do not accurately reflect behavior of the paint layer in the golf ball. The spin performance of these golf balls is not sufficient.

In addition, the elastic modulus disclosed in JP2016-123632 (US2016/0184654 A1) is measured with a scanning probe microscope. Therefore, the measurement results are influenced by the physical properties of a cover under the paint layer. The spin performance of the golf ball disclosed in JP2016-123632 is not sufficient.

An object of the present invention is to provide a golf ball having excellent controllability upon approach shots in a dry state and in a wet state and further having excellent feel at impact and stain resistance.

### SUMMARY OF THE INVENTION

A golf ball according to the present invention includes a main body and a paint layer positioned outside the main body. The paint layer includes an inner layer and an outer layer positioned outside the inner layer. When an indentation depth (mm) is measured on a cross-section along a plane passing through a central point of the golf ball when a force of 30 mgf is applied to the cross-section in a direction perpendicular to the cross-section, an indentation depth Di on a cross section of the inner layer is lower than an indentation depth Do on a cross-section of the outer layer.

With the golf ball according to the present invention, high spin rates in a dry state and in a wet state are achieved since the golf ball includes the paint layer in which the indentation depth Di of the inner layer is lower than the indentation depth Do of the outer layer. The golf ball has excellent controllability upon approach shots in a dry state and in a wet state. Furthermore, the golf ball has excellent feel at impact and excellent stain resistance.

Preferably, the indentation depth Di is less than 1000 nm. Preferably, the indentation depth Do is not less than 1000 nm. Preferably, a difference (Do−Di) between the indentation depth Do and the indentation depth Di is not less than 50 nm and not greater than 1800 nm.

Preferably, the inner layer has a thickness Ti of not less than 5 μm and not greater than 50 μm. Preferably, the outer layer has a thickness To of not less than 5 μm and not greater than 50 μm.

The main body may include a core and a cover positioned outside the core. The cover has a Shore D hardness Hc of not less than 50 and not greater than 80. When the paint layer is laminated on the cover, the difference (Do−Di) is preferably not less than 50 nm and not greater than 1000 nm.

The cover may have a Shore D hardness Hc of equal to or greater than 20 and less than 50. When the paint layer is laminated on the cover, the difference (Do−Di) is preferably not less than 200 nm and not greater than 1800 nm. The main body may further include a mid layer between the core and the cover.

### BRIEF DESCRIPTION OF THE DRAWINGS

FIG. 1 is a partially cutaway cross-sectional view of a golf ball according to one embodiment of the present invention; and

FIG. 2 is a partially cutaway cross-sectional view of a golf ball according to another embodiment of the present invention.

### DESCRIPTION OF THE PREFERRED EMBODIMENTS

The following will describe in detail the present invention based on preferred embodiments with appropriate reference to the drawings.

### First Embodiment

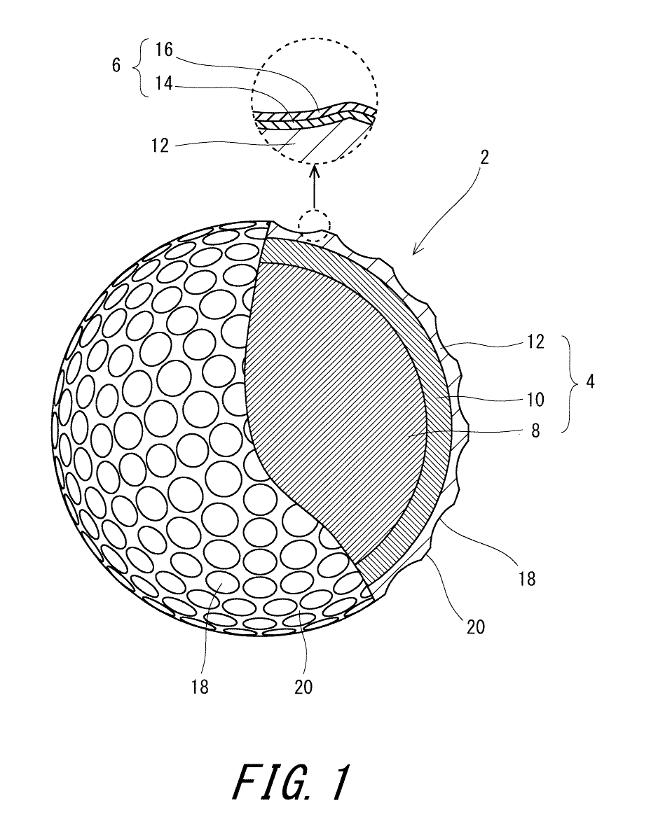

A golf ball 2 shown in FIG. 1 includes a main body 4 and a paint layer 6 positioned outside the main body 4. The main body 4 includes a spherical core 8, a mid layer 10 positioned outside the core 8, and a cover 12 positioned outside the mid layer 10. The paint layer 6 includes an inner layer 14 positioned outside the cover 12, and an outer layer 16 positioned outside the inner layer 14. The golf ball 2 has a plurality of dimples 18 on the surface thereof. Of the surface of the golf ball 2, a part other than the dimples 18 is a land 20. The golf ball 2 may include a mark layer. The mark layer may be positioned between the cover 12 and the paint layer 6, or may be positioned outside the paint layer 6. The mark layer may be positioned between the inner layer 14 and the outer layer 16. The paint layer 6 can further include another layer between the inner layer 14 and the outer layer 16.

The golf ball 2 preferably has a diameter of not less than 40 mm and not greater than 45 mm. From the viewpoint of conformity to the rules established by the United States Golf Association (USGA), the diameter is particularly preferably not less than 42.67 mm. In light of suppression of air resistance, the diameter is more preferably not greater than 44 mm and particularly preferably not greater than 42.80 mm. The golf ball 2 preferably has a weight of not less than 40 g and not greater than 50 g. In light of attainment of great inertia, the weight is more preferably not less than 44 g and particularly preferably not less than 45.00 g. From the viewpoint of conformity to the rules established by the USGA, the weight is particularly preferably not greater than 45.93 g.

In light of feel at impact, the golf ball 2 has an amount of compressive deformation Sb of preferably not less than 1.80 mm, more preferably not less than 1.90 mm, and particularly preferably not less than 2.00 mm. In light of spin performance, the amount of compressive deformation Sb is preferably not greater than 3.30 mm, more preferably not greater than 3.20 mm, and particularly preferably not greater than 3.10 mm. The method for measuring the amount of compressive deformation Sb will be described later.

The core 8 is formed by crosslinking a rubber composition. Examples of the base rubber of the rubber composition include polybutadienes, polyisoprenes, styrene-butadiene copolymers, ethylene-propylene-diene copolymers, and natural rubbers. Two or more rubbers may be used in combination. In light of resilience performance, polybutadienes are preferable, and high-cis polybutadienes are particularly preferable.

The rubber composition of the core 8 preferably includes a co-crosslinking agent. Examples of preferable co-crosslinking agents in light of resilience performance include zinc acrylate, magnesium acrylate, zinc methacrylate, and magnesium methacrylate. The rubber composition preferably includes an organic peroxide together with a co-crosslinking agent. Examples of preferable organic peroxides include dicumyl peroxide, 1,1-bis(t-butylperoxy)-3,3,5-trimethylcyclohexane, 2,5-dimethyl-2,5-di(t-butylperoxy)hexane, and di-t-butyl peroxide. An organic peroxide with particularly high versatility is dicumyl peroxide.

The rubber composition of the core 8 can include an organic sulfur compound. Examples of the organic sulfur compound include: naphthalenethiol compounds such as 1-naphthalenethiol, 2-naphthalenethiol, 4-chloro-1-naphthalenethiol, and the like; benzenethiol compounds such as benzenethiol, 4-chlorobenzenethiol, 3-bromobenzenethiol, 4-cyanobenzenethiol, and the like; and disulfide compounds such as diphenyl sulfide, bis(4-chlorophenyl)disulfide, bis(2,5-dichlorophenyl)disulfide, bis(2,4,6-trichlorophenyl)disulfide, bis(2,3,4,5,6-pentabromophenyl)disulfide (PBPS), and the like. 2-naphthalenethiol, diphenyl sulfide, and bis(2,3,4,5,6-pentabromophenyl)disulfide (PBPS) are preferable. Two or more organic sulfur compounds may be used in combination.

The rubber composition of the core 8 may include a carboxylic acid and/or a metal salt thereof in addition to the aforementioned co-crosslinking agent. A carboxylic acid including a carboxylic acid component having 1 to 30 carbon atoms and/or a metal salt thereof is preferable. Examples of preferable carboxylic acids include: saturated fatty acids such as octanoic acid, lauric acid, myristic acid, stearic acid, and the like; unsaturated fatty acids such as 10-undecylenic acid, myristoleic acid, palmitoleic acid, oleic acid, linolic acid, and the like; aromatic carboxylic acids such as benzoic acid, phthalic acid, salicylic acid, and the like; and the like. Examples of the metal component forming the carboxylic acid metal salt include magnesium, calcium, zinc, barium, and the like.

In light of spin suppression, the amount of the carboxylic acid and/or the metal salt thereof per 100 parts by weight of the base rubber is preferably not less than 0.5 parts by weight and more preferably not less than 1.0 parts by weight. In light of controllability, the amount of the carboxylic acid and/or the metal salt thereof per 100 parts by weight of the base rubber is preferably not greater than 30 parts by weight and more preferably not greater than 20 parts by weight. Two or more carboxylic acids and/or metal salts thereof may be used in combination.

The rubber composition of the core 8 may include a filler for specific gravity adjustment and the like. Examples of suitable fillers include zinc oxide, barium sulfate, calcium carbonate, and magnesium carbonate. The amount of the filler is determined as appropriate so that the intended specific gravity of the core 8 is accomplished. Furthermore, this rubber composition can include additives such as sulfur, an anti-aging agent, a coloring agent, a plasticizer, and a dispersant. The rubber composition may include synthetic resin powder or crosslinked rubber powder.

The core 8 has a weight of preferably not less than 10 g and not greater than 42 g. The temperature for crosslinking the core 8 is not lower that 140° C. and not higher than 180° C. The time for crosslinking the core 8 is not shorter than 10 minutes and not longer than 60 minutes.

In light of resilience performance, the core 8 has a diameter of preferably not less than 30.0 mm and particularly preferably not less than 38.0 mm. In light of spin performance, the diameter of the core 8 is preferably not greater than 42.0 mm and particularly preferably not greater than 41.5 mm. The core 8 may have two or more layers. The core 8 may have a rib on the surface thereof. The core 8 may be hollow.

In light of controllability and durability, a Shore C hardness Ho at the central point of the core 8 is preferably not less than 40 and more preferably not less than 50. In light of feel at impact, the hardness Ho is preferably not greater than 75 and more preferably not greater than 65. In light of approach performance, a Shore C hardness Hs at the surface of the core 8 is preferably not less than 60 and more preferably not less than 70. In light of feel at impact, the hardness Hs is preferably not greater than 95 and more preferably not greater than 90.

In light of flight performance, the difference (Hs−Ho) between the hardness Hs and the hardness Ho is preferably not less than 10 and more preferably not less than 15. From the viewpoint of not excessively suppressing the spin performance of the golf ball 2, the difference (Hs−Ho) is preferably not greater than 40 and more preferably not greater than 35.

The hardness Ho is measured by pressing a Shore C type hardness scale mounted to an automated hardness meter (trade name “digi test II” manufactured by Heinrich Bareiss Prufgeratebau GmbH), against the central point of the cross-section of a hemisphere obtained by cutting the core 8. The hardness Hs is measured by pressing this hardness meter against the surface of the core 8. Both measurements are conducted in an environment of 23° C.

In light of feel at impact, the core 8 has an amount of compressive deformation Sc of preferably not less than 2.50 mm, more preferably not less than 2.60 mm, and particularly preferably not less than 2.70 mm. In light of resilience performance, the amount of compressive deformation Sc is preferably not greater than 3.90 mm, more preferably not greater than 3.80 mm, and particularly preferably not greater than 3.70 mm. The method for measuring the amount of compressive deformation Sc will be described later.

In the golf ball 2, the mid layer 10 is formed outside the core 8. The mid layer 10 may include two or more layers. Another layer may be further provided between the mid layer 10 and the core 8.

The mid layer 10 is formed from a resin composition. A preferable base polymer of the resin composition is an ionomer resin. Examples of preferable ionomer resins include binary copolymers formed with an α-olefin and an α,β-unsaturated carboxylic acid having 3 to 8 carbon atoms. Examples of other preferable ionomer resins include ternary copolymers formed with: an α-olefin; an α,β-unsaturated carboxylic acid having 3 to 8 carbon atoms; and an α,β-unsaturated carboxylate ester having 2 to 22 carbon atoms. For the binary copolymer and the ternary copolymer, preferable α-olefins are ethylene and propylene, while preferable α,β-unsaturated carboxylic acids are acrylic acid and methacrylic acid. In the binary copolymer and the ternary copolymer, some of the carboxyl groups are neutralized with metal ions. Examples of metal ions for use in neutralization include sodium ion, potassium ion, lithium ion, zinc ion, calcium ion, magnesium ion, aluminum ion, and neodymium ion.

Instead of an ionomer resin or together with an ionomer resin, the resin composition of the mid layer 10 may include another polymer. Examples of the other polymer include polystyrenes, polyamides, polyesters, polyolefins, and polyurethanes. The resin composition may include two or more polymers.

The resin composition of the mid layer 10 may include a coloring agent such as titanium dioxide, a filler such as barium sulfate, a dispersant, an antioxidant, an ultraviolet absorber, a light stabilizer, a fluorescent material, a fluorescent brightener, and the like. For the purpose of adjusting specific gravity, the resin composition may include powder of a metal with a high specific gravity such as tungsten, molybdenum, and the like.

In light of durability and flight performance, the mid layer 10 has a Shore D hardness Hm of preferably not less than 40 and particularly preferably not less than 50. In light of controllability and feel at impact, the hardness Hm is preferably not greater than 90 and particularly preferably not greater than 80. In the case where the mid layer 10 includes two or more layers, the hardness of each layer forming the mid layer 10 preferably satisfies this numerical range. The method for measuring the hardness Hm will be described later.

In light of durability and flight performance, the mid layer 10 has a thickness Tm of preferably not less than 0.2 mm and particularly preferably not less than 0.5 mm. In light of feel at impact, the thickness Tm is preferably not greater than 2.5 mm and particularly preferably not greater than 2.2 mm. The thickness Tm of the mid layer 10 is measured at a position immediately below the land 20. In the case where the mid layer 10 includes two or more layers, the total thickness of all the layers forming the mid layer 10 preferably satisfies this numerical range.

The mid layer 10 has a specific gravity of preferably not less than 0.90 and particularly preferably not less than 0.95. The specific gravity of the mid layer 10 is preferably not greater than 1.10 and particularly preferably not greater than 1.05.

In the golf ball 2, the cover 12 is formed outside the mid layer 10. The cover 12 may include two or more layers. Another layer may be further provided between the mid layer 10 and the cover 12.

The cover 12 is formed from a resin composition. A preferable base polymer of the resin composition is a polyurethane. The resin composition may include a thermoplastic polyurethane or may include a thermosetting polyurethane. In light of productivity, the thermoplastic polyurethane is preferable. The thermoplastic polyurethane includes a polyurethane component as a hard segment, and a polyester component or a polyether component as a soft segment. The cover 12 the base material of which is the polyurethane can contribute to the spin performance of the golf ball 2. Furthermore, the cover 12 can also contribute to the feel at impact of the golf ball 2.

The polyurethane has a urethane bond within the molecule. The urethane bond can be formed by reacting a polyol with a polyisocyanate.

The polyol, which is a material for the urethane bond, has a plurality of hydroxyl groups. Low-molecular-weight polyols and high-molecular-weight polyols can be used.

Examples of an isocyanate for the polyurethane component include alicyclic diisocyanates, aromatic diisocyanates, and aliphatic diisocyanates. Alicyclic diisocyanates are particularly preferable. Since an alicyclic diisocyanate does not have any double bond in the main chain, the alicyclic diisocyanate suppresses yellowing of the cover 12. Examples of alicyclic diisocyanates include 4,4′-dicyclohexylmethane diisocyanate (H₁₂MDI), 1,3-bis(isocyanatomethyl)cyclohexane (H₆XDI), isophorone diisocyanate (IPDI), and trans-1,4-cyclohexane diisocyanate (CHDI). In light of versatility and processability, H₁₂MDI is preferable.

Instead of a polyurethane, the resin composition of the cover 12 may include another polymer. Examples of the other polymer include ionomer resins, polystyrenes, polyamides, polyesters, and polyolefins. The resin composition may include two or more polymers.

The resin composition of the cover 12 may include a coloring agent such as titanium dioxide, a filler such as barium sulfate, a dispersant, an antioxidant, an ultraviolet absorber, a light stabilizer, a fluorescent material, a fluorescent brightener, and the like.

In the golf ball 2, the cover 12 preferably has a Shore D hardness Hc of equal to or greater than 20 and less than 50. The golf ball 2 that includes the cover 12 having a hardness Hc of equal to or greater than 20 has excellent stain resistance and excellent durability. From this viewpoint, the hardness Hc of the cover 12 is more preferably not less than 22 and particularly preferably not less than 24. The golf ball 2 that includes the cover 12 having a hardness Hc of less than 50 has excellent spin performance and excellent feel at impact upon an approach shot. From this viewpoint, the hardness Hc of the cover 12 is more preferably not greater than 48 and particularly preferably not greater than 46. In the case where the cover 12 includes two or more layers, the hardness of each layer forming the cover 12 preferably satisfies this numerical range.

The hardness of the cover 12 (or the mid layer 10) is measured according to the standards of “ASTM-D 2240-68”. The hardness is measured with a Shore D type hardness scale mounted to an automated hardness meter (trade name “digi test II” manufactured by Heinrich Bareiss Prufgeratebau GmbH). For the measurement, a sheet that is formed by hot press, is formed from the same material as that of the cover 12 (or the mid layer 10), and has a thickness of about 2 mm is used. Prior to the measurement, a sheet is kept at 23° C. for two weeks. At the measurement, three sheets are stacked.

In the golf ball 2, the cover 12 preferably has a thickness Tc of not less than 0.1 mm and not greater than 2.0 mm. The cover 12 having a thickness Tc of not less than 0.1 mm contributes to spin performance and feel at impact upon an approach shot. From this viewpoint, the thickness Tc of the cover 12 is more preferably not less than 0.3 mm and particularly preferably not less than 0.4 mm. The golf ball 2 that includes the cover 12 having a thickness Tc of not greater than 2.0 mm has excellent flight performance. From this viewpoint, the thickness Tc of the cover 12 is more preferably not greater than 1.5 mm and particularly preferably not greater than 1.0 mm. The thickness Tc of the cover 12 is measured at a position immediately below the land 20. In the case where the cover 12 includes two or more layers, the total thickness of all the layers forming the cover 12 preferably satisfies this numerical range.

The golf ball 2 may include a reinforcing layer between the mid layer 10 and the cover 12. The reinforcing layer firmly adheres to the mid layer 10 and also to the cover 12. The reinforcing layer suppresses separation of the cover 12 from the mid layer 10. The reinforcing layer is formed from a polymer composition. Examples of the base polymer of the reinforcing layer include two-component curing type epoxy resins and two-component curing type urethane resins.

In the golf ball 2, the paint layer 6 is formed outside the cover 12. As shown, the paint layer 6 includes the inner layer 14 and the outer layer 16. In the present invention, an indentation depth Di of the inner layer 14 and an indentation depth Do of the outer layer 16 are measured.

In another embodiment, the paint layer 6 may include three or more layers. Among the three or more layers forming the paint layer 6, the layer that is closest to the cover 12 is referred to as innermost layer, and the layer that is furthest from the cover 12 is referred to as outermost layer. In this embodiment, an indentation depth of the inner most layer of the paint layer 6 is measured as Di, and an indentation depth of the outermost layer of the paint layer 6 is measured as Do.

In measurement of the indentation depth, the golf ball 2 is divided to obtain a hemisphere. On the hemisphere, a cross-section passing through the central point of the golf ball 2 is exposed. The cross-section includes a cross-section of the paint layer 6. The cross-section of the paint layer 6 includes a cross-section of the inner layer 14 and a cross-section of the outer layer 16. The cross-section of the hemisphere is made horizontal by a cryo-microtome. A penetrator of a nanoindenter is brought into contact with this cross-section and pressed against the cross-section in a direction perpendicular to the cross-section. Due to this pressing, the penetrator advances. A load and an advancing distance of the penetrator are measured. The conditions at the measurement are as follows.

Nanoindenter: “ENT-2100” manufactured by ELIONIX INC.

Temperature: 30° C.

Penetrator: Berkovich penetrator (65.03° As(h)=26.43 h²)

Number of partitions: 500 steps

Step interval: 20 msec (100 mgf)

The load of the penetrator is gradually increased until reaching 50 mgf. When the load is 30 mgf, the advancing distance (nm) of the penetrator is measured as an indentation depth.

An advancing distance of the penetrator measured on the cross-section of the inner layer 14 in the cross-section along a plane passing through the central point of the golf ball 2 is the indentation depth Di of the inner layer 14.

An advancing distance of the penetrator measured on the cross-section of the outer layer 16 is the indentation depth Do of the outer layer 16. The indentation depth Di and the indentation depth Do are measured without influence of the hardness of the cover 12. The hardness of the inner layer 14 is accurately evaluated on the basis of the indentation depth Di. The hardness of the outer layer 16 is accurately evaluated on the basis of the indentation depth Do.

In the present invention, the indentation depth Di of the inner layer 14 is lower than the indentation depth Do of the outer layer 16. In other words, the inner layer 14 is harder than the outer layer 16. The hard inner layer 14 contributes to a high spin rate in a wet state. In the golf ball 2, controllability upon an approach shot in a wet state is improved by the inner layer 14 having a low indentation depth Di. Meanwhile, the outer layer 16 is flexible as compared to the inner layer 14. The flexible outer layer 16 contributes to a high spin rate in a dry state. The golf ball 2 including the outer layer 16 has excellent controllability upon an approach shot in a dry state.

In light of stain resistance and controllability in a wet state, the indentation depth Di of the inner layer 14 is preferably less than 1000 nm, more preferably not greater than 900 nm, and particularly preferably not greater than 800 nm. In light of feel at impact and controllability in a dry state, the indentation depth Di of the inner layer 14 is preferably not less than 100 nm, more preferably not less than 200 nm, and particularly preferably not less than 300 nm.

In light of feel at impact and controllability in a dry state, the indentation depth Do of the outer layer 16 is preferably not less than 1000 nm, more preferably not less than 1100 nm, and particularly preferably not less than 1200 nm. In light of stain resistance and controllability in a wet state, the indentation depth Do of the outer layer 16 is preferably not greater than 3000 nm, more preferably not greater than 2900 nm, and particularly preferably not greater than 2800 nm.

In light of achievement of desired controllability both in a wet state and in a dry state, the difference (Do-Di) between the indentation depth Do of the outer layer 16 and the indentation depth Di of the inner layer 14 is preferably not less than 50 nm, more preferably not less than 70 nm, and further preferably not less than 90 nm. In light of durability of the paint layer 6, the difference (Do−Di) is preferably not greater than 1800 nm, more preferably not greater than 1700 nm, and further preferably not greater than 1600 nm.

As described above, in the golf ball 2, the cover 12 contributes to spin performance upon an approach shot. In light of the synergetic effect with the cover 12 having a hardness Hc of equal to or greater than 20 and less than 50, the difference (Do−Di) is more preferably not less than 200 nm and not greater than 1800 nm. In the golf ball 2 that includes the cover 12 having a hardness Hc of equal to or greater than 20 and less than 50 and the paint layer 6 having a difference (Do−Di) of not less than 200 nm and not greater than 1800 nm, controllability both in a wet state and in a dry state is achieved at a high level.

In light of spin performance upon an approach shot, the inner layer 14 has a thickness Ti of preferably not less than 5 μm, more preferably not less than 6 μm, and particularly preferably not less than 7 μm. From the same viewpoint, the thickness Ti is preferably not greater than 50 μm, more preferably not greater than 40 μm, and particularly preferably not greater than 30 μm.

In light of spin performance upon an approach shot, the outer layer 16 has a thickness To of preferably not less than 5 μm, more preferably not less than 6 μm, and particularly preferably not less than 7 μm. From the same viewpoint, the thickness To is preferably not greater than 50 μm, more preferably not greater than 40 μm, and particularly preferably not greater than 30 μm.

The sum (Ti+To) of the thickness Ti of the inner layer 14 and the thickness To of the outer layer 16 is preferably not less than 10 μm and not greater than 100 μm. In the case where the paint layer 6 includes another layer between the inner layer 14 and the outer layer 16, the total thickness of all the layers forming the paint layer 6 is set to be not less than 10 μm and not greater than 100 μm. The paint layer 6 having a total thickness of not less than 10 μm can contribute to high spin rates in a dry state and in a wet state. From this viewpoint, the total thickness of the paint layer 6 is more preferably not less than 12 μm and particularly preferably not less than 14 μm. In the golf ball 2 that includes the paint layer 6 having a total thickness of not greater than 100 μm, the effect achieved by the cover 12 is not impaired. From this viewpoint, the total thickness is more preferably not greater than 80 μm and particularly preferably not greater than 60 μm.

In light of controllability in a dry state, the ratio (To/Ti) of the thickness To of the outer layer 16 relative to the thickness Ti of the inner layer 14 is preferably not less than 0.2, more preferably not less than 0.3, and particularly preferably not less than 0.4. In light of controllability in a wet state, the ratio (To/Ti) is preferably not greater than 5, more preferably not greater than 4, and particularly preferably not greater than 3.

The inner layer 14 is formed from a resin composition. Examples of the base resin of the resin composition include polyurethanes, epoxy resins, acrylic resins, polyvinyl acetate resins, and polyesters. Particularly preferable base resins are polyurethanes.

The outer layer 16 is formed from a resin composition. Examples of the base resin of the resin composition include polyurethanes, epoxy resins, acrylic resins, polyvinyl acetate resins, and polyesters. Particularly preferable base resins are polyurethanes.

Typically, each of the inner layer 14 and the outer layer 16 is formed from a polyurethane paint. The paint contains (A) a polyol composition and (B) a polyisocyanate composition. In the paint, the polyol composition (A) is a base material, and the polyisocyanate composition (B) is a curing agent.

The polyol composition (A) contains a polyol compound. The polyol compound has two or more hydroxyl groups within the molecule thereof. The polyol compound may be (a1) a polyol compound having a hydroxyl group at an end of the molecular chain thereof, or may be (a2) a polyol compound having a hydroxyl group at a portion of the molecular chain other than the ends thereof. The polyol composition (A) may contain two or more polyol compounds.

The polyol compound (a1) having a hydroxyl group at an end of the molecular chain thereof includes a low-molecular-weight polyol and a high-molecular-weight polyol. The low-molecular-weight polyol has a number average molecular weight of less than 500. The high-molecular-weight polyol has a number average molecular weight of not less than 500. Examples of the low-molecular-weight polyol include: diols such as ethylene glycol, diethylene glycol, triethylene glycol, 1,3-butanediol, 1,4-butanediol, neopentyl glycol, and 1,6-hexanediol; and triols such as glycerin, trimethylol propane, and hexanetriol.

Examples of the high-molecular-weight polyol include: polyether polyols, polyester polyols, polycaprolactone polyols, polycarbonate polyols, urethane polyols, and acrylic polyols. Examples of polyether polyols include polyoxyethylene glycol (PEG), polyoxypropylene glycol (PPG), and polyoxytetramethylene glycol (PTMG). Examples of polyester polyols include polyethylene adipate (PEA), polybutylene adipate (PBA), and polyhexamethylene adipate (PHMA). Examples of polycaprolactone polyols include poly-ε-caprolactone (PCL). Examples of polycarbonate polyols include polyhexamethylene carbonate.

The urethane polyol has two or more urethane bonds and two or more hydroxyl groups. The urethane polyol can be obtained by causing a reaction of a polyol component and a polyisocyanate component under a condition that the hydroxyl groups of the polyol component are excessive with respect to the isocyanate groups of the polyisocyanate component.

Examples of the polyol component, which is a starting material of the urethane polyol, include polyether diols, polyester diols, polycaprolactone diols, and polycarbonate diols. A preferable polyol component is a polyether diol. A preferable polyol component is a polyether diol such as polyoxyethylene glycol, polyoxypropylene glycol, polyoxytetramethylene glycol, or the like. Polyoxytetramethylene glycol is more preferable.

The polyether diol preferably has a number average molecular weight of not less than 550. The polyether diol having a number average molecular weight of not less than 550 can contribute to spin performance. From this viewpoint, the molecular weight is more preferably not less than 600 and particularly preferably not less than 630. The molecular weight is preferably not greater than 3,000. The polyether diol having a molecular weight of not greater than 3,000 can contribute to the stain resistance of the paint layer 6. From this viewpoint, the molecular weight is more preferably not greater than 2,500 and particularly preferably not greater than 2,000. The number average molecular weight of the polyol component is measured by gel permeation chromatography (GPC). The measurement conditions are as follows.

Reference material: polystyrene

Eluant: tetrahydrofuran

Column: organic solvent GPC column (“Shodex KF Series” manufactured by Showa Denko K.K.)

A urethane polyol including 60% by weight or greater of a polyether diol is preferable. The urethane polyol can contribute to spin performance. From this viewpoint, the content of the polyether diol in the urethane polyol is more preferably not less than 62% by weight and particularly preferably not less than 65% by weight.

A low-molecular-weight polyol can be used as the polyol component, which is the starting material of the urethane polyol. Examples of the low-molecular-weight polyol include: diols such as ethylene glycol, diethylene glycol, triethylene glycol, 1,3-butanediol, 1,4-butanediol, neopentyl glycol, and 1,6-hexanediol; and triols such as glycerin, trimethylol propane, and hexanetriol. Two or more low-molecular-weight polyols may be used as the starting material.

The polyisocyanate component, which is a starting material of the urethane polyol, has two or more isocyanate groups. Examples of the polyisocyanate component include: aromatic polyisocyanates such as 2,4-toluene diisocyanate, 2,6-toluene diisocyanate, a mixture (TDI) of 2,4-toluene diisocyanate and 2,6-toluene diisocyanate, 4,4′-diphenylmethane diisocyanate (MDI), 1,5-naphthylene diisocyanate (NDI), 3,3′-bitolylene-4,4′-diisocyanate (TODI), xylylene diisocyanate (XDI), tetramethylxylylene diisocyanate (TMXDI), and paraphenylene diisocyanate (PPDI); alicyclic polyisocyanates such as 4,4′-dicyclohexylmethane diisocyanate (H₁₂MDI), hydrogenated xylylene diisocyanate (H₆XDI), hexamethylene diisocyanate (HDI), isophorone diisocyanate (IPDI), and norbornene diisocyanate (NBDI); and aliphatic diisocyanates. As the starting material, two or more polyisocyanates may be used.

The urethane polyol preferably has a weight average molecular weight of not less than 4,000. The urethane polyol having a weight average molecular weight of not less than 4,000 can contribute to spin performance. From this viewpoint, the molecular weight is more preferably not less than 4,300 and particularly preferably not less than 4,500. The molecular weight is preferably not greater than 20,000. The urethane polyol having a molecular weight of not greater than 20,000 can contribute to the stain resistance of the paint layer 6. From this viewpoint, the molecular weight is more preferably not greater than 18,000 and particularly preferably not greater than 16,000.

The urethane polyol has a hydroxyl value of preferably not less than 10 mg KOH/g, more preferably not less than 15 mg KOH/g, and particularly preferably not less than 20 mg KOH/g. The hydroxyl value is preferably not greater than 200 mg KOH/g, more preferably not greater than 190 mg KOH/g, and particularly preferably not greater than 180 mg KOH/g. The hydroxyl value is measured according to the standards of “JIS K 1557-1”. For the measurement, the acetylation method is adopted.

Examples of the polyol compound (a2) having a hydroxyl group at the portion of the molecule other than the ends thereof include a modified polyrotaxane having a hydroxyl group, and a hydroxyl group-modified vinyl chloride-vinyl acetate copolymer.

The modified polyrotaxane having a hydroxyl group has cyclodextrins, a linear molecule, and a blocking group. The cyclodextrins are ring molecules. The linear molecule is threaded through the cyclodextrins. The blocking group is located at each of both ends of the linear molecule. The blocking group prevents detachment of the cyclodextrins from the linear molecule. In the polyrotaxane, the cyclodextrins are movable along the linear molecule. When tension is applied to the paint layer 6 including the polyrotaxane, the tension is distributed. In the paint layer 6, cracking and scuff are less likely to occur.

The cyclodextrins are oligosaccharides having a ring structure. In the cyclodextrins, 6 to 8 D-glucopyranose units are linked to each other by α-1,4-glucoside linkage to form a ring. Examples of the cyclodextrins include α-cyclodextrin (the number of glucoses: 6), β-cyclodextrin (the number of glucoses: 7), and γ-cyclodextrin (the number of glucoses: 8). α-cyclodextrin is preferable. Two or more types of cyclodextrins may be used in combination.

Examples of the linear molecule threaded through the cyclodextrins include polyalkylenes, polyesters, polyethers, and polyacrylics. Polyethers are preferable, and polyethylene glycol is particularly preferable.

The weight average molecular weight of the linear molecule is preferably not less than 5,000 and particularly preferably not less than 6,000. The molecular weight is preferably not greater than 100,000 and particularly preferably not greater than 80,000.

A linear molecule having functional groups at both ends thereof is preferable. The linear molecule can easily react with the blocking group. Examples of the functional groups include hydroxyl group, carboxy group, amino group, and thiol group.

Examples of a method for preventing detachment of the cyclodextrins by the blocking group include a physical prevention method with a bulky blocking group, and an electrostatic prevention method with an ionic blocking group. Examples of the bulky blocking group include cyclodextrins and adamantane group. The ratio of the number of the cyclodextrins through which the linear molecule is threaded, relative to the maximum number of the cyclodextrins, is preferably not less than 0.06 and not greater than 0.61, more preferably not less than 0.11 and not greater than 0.48, and particularly preferably not less than 0.24 and not greater than 0.41. The paint layer 6 in which the ratio falls within the above range has excellent physical properties.

A polyrotaxane in which at least a part of the hydroxyl groups included in each cyclodextrin is modified with a caprolactone chain is preferable. With the polyrotaxane, steric hindrance between the polyrotaxane and a polyisocyanate compound which is a curing agent is alleviated.

Hereinafter, one example of a method for the modification will be described. First, the hydroxyl groups of each cyclodextrin are treated with propylene oxide to be hydroxypropylated. Next, ε-caprolactone is added to cause ring-opening polymerization. Accordingly, a caprolactone chain —(CO(CH₂)₅O)nH is bonded to the outside of the ring structure of the cyclodextrin via a —O—C₃H₆—O— group. The “n” represents a degree of polymerization, and is preferably a natural number of 1 to 100, more preferably a natural number of 2 to 70, and particularly preferably a natural number of 3 to 40. By the ring-opening polymerization, a hydroxyl group is formed at the other end of the caprolactone chain. The hydroxyl group can react with the polyisocyanate compound.

The proportion of the hydroxyl groups modified with a caprolactone chain to all the hydroxyl groups (100 mol %) included in the cyclodextrin that has not been modified is preferably not less than 2 mol %, more preferably not less than 5 mol %, and further preferably not less than 10 mol %. The polyrotaxane in which the proportion falls within the above range is hydrophobic. The reactivity of the polyrotaxane with the polyisocyanate compound is high.

The polyrotaxane preferably has a hydroxyl value of not less than 10 mg KOH/g and not greater than 400 mg KOH/g. The reactivity of the polyrotaxane with the polyisocyanate compound is high. From this viewpoint, the hydroxyl value is more preferably not less than 15 mg KOH/g and particularly preferably not less than 20 mg KOH/g. The hydroxyl value is more preferably not greater than 300 mg KOH/g and particularly preferably not greater than 220 mg KOH/g.

The polyrotaxane preferably has a weight average molecular weight of not less than 30,000 and not greater than 3,000,000. The polyrotaxane having a molecular weight of not less than 30,000 can contribute to the strength of the paint layer 6. From this viewpoint, the molecular weight is more preferably not less than 40,000 and particularly preferably not less than 50,000. The polyrotaxane having a molecular weight of not greater than 3,000,000 can contribute to the flexibility of the paint layer 6. From this viewpoint, the molecular weight is more preferably not greater than 2,500,000 and particularly preferably not greater than 2,000,000. The molecular weight is measured by gel permeation chromatography (GPC). The measurement conditions are as follows.

Reference material: polystyrene

Eluant: tetrahydrofuran

Column: organic solvent GPC column (“Shodex KF Series” manufactured by Showa Denko K.K.)

Specific examples of the polyrotaxane modified with polycaprolactone include trade names “SeRM Super Polymer SH3400P”, “SeRM Super Polymer SH2400P”, and “SeRM Super Polymer SH1310P”, manufactured by Advanced Softmaterials Inc.

The hydroxyl group-modified vinyl chloride-vinyl acetate copolymer which is one example of the polyol compound (a2) having a hydroxyl group at the portion of the molecular chain other than the ends thereof can contribute to the spin performance of the golf ball 2. The copolymer can be obtained by copolymerization of a monomer having a hydroxyl group, vinyl chloride, and vinyl acetate. Examples of the monomer having a hydroxyl group include polyvinyl alcohol and hydroxyalkyl acrylate. The copolymer can also be obtained by partial saponification or full saponification of a vinyl chloride-vinyl acetate copolymer.

The content of the vinyl chloride component in the hydroxyl group-modified vinyl chloride-vinyl acetate copolymer is preferably not less than 1% by weight, more preferably not less than 20% by weight, and particularly preferably not less than 50% by weight. The content is preferably not greater than 99% by weight and particularly preferably not greater than 95% by weight. Specific examples of the hydroxyl group-modified vinyl chloride-vinyl acetate copolymer include trade names “Solbin A”, “Solbin AL”, and “Solbin TA3”, manufactured by Nissin Chemical Industry Co., Ltd.

As embodiments of a preferable polyol composition (A), the following is exemplified.

Embodiment 1: a composition including a urethane polyol containing a polyether diol having a number average molecular weight of not less than 550 and not greater than 3,000.

Embodiment 2: a composition including a polyrotaxane in which at least a part of the hydroxyl groups included in each cyclodextrin is modified with a caprolactone chain via a —O—C₃H₆—O— group.

The proportion of the urethane polyol to the entire polyol compound in the polyol composition (A) of Embodiment 1 is preferably not less than 60% by weight, more preferably not less than 70% by weight, and particularly preferably not less than 80% by weight. The polyol composition (A) may include only the urethane polyol as the polyol compound.

The proportion of the polyrotaxane to the entire polyol compound in the polyol composition (A) of Embodiment 2 is preferably not less than 10% by weight, more preferably not less than 15% by weight, and particularly preferably not less than 20% by weight. The proportion is preferably not greater than 100% by weight, more preferably not greater than 90% by weight, and particularly preferably not greater than 85% by weight.

The polyol composition (A) of Embodiment 2 preferably contains a polycaprolactone polyol. The weight ratio of the polycaprolactone polyol and the polyrotaxane is preferably not less than 0/100, more preferably not less than 5/95, and particularly preferably not less than 10/90. The ratio is preferably not greater than 90/10, more preferably not greater than 85/15, and particularly preferably not greater than 80/20.

The polyol composition (A) of Embodiment 2 preferably contains the aforementioned hydroxyl group-modified vinyl chloride-vinyl acetate copolymer. The proportion of the hydroxyl group-modified vinyl chloride-vinyl acetate copolymer to the entire polyol compound in the polyol composition (A) is preferably not less than 4% by weight and particularly preferably not less than 8% by weight. The proportion is preferably not greater than 50% by weight and particularly preferably not greater than 45% by weight.

The polyisocyanate composition (B) which is a curing agent contains a polyisocyanate compound. The polyisocyanate compound has two or more isocyanate groups.

Examples of the polyisocyanate compound include: aromatic diisocyanates such as 2,4-toluene diisocyanate, 2,6-toluene diisocyanate, a mixture (TDI) of 2,4-toluene diisocyanate and 2,6-toluene diisocyanate, 4,4′-diphenylmethane diisocyanate (MDI), 1,5-naphthylene diisocyanate (NDI), 3,3′-bitolylene-4,4′-diisocyanate (TODI), xylylene diisocyanate (XDI), tetramethylxylylene diisocyanate (TMXDI), and paraphenylene diisocyanate (PPDI); alicyclic or aliphatic diisocyanates such as 4,4′-dicyclohexylmethane diisocyanate (H₁₂MDI), hydrogenated xylylene diisocyanate (H₆XDI), hexamethylene diisocyanate (HDI), isophorone diisocyanate (IPDI), and norbornene diisocyanate (NBDI); and triisocyanates such as an allophanate product, a biuret product, an isocyanurate product, an adduct product of diisocyanates. The polyisocyanate composition (B) may include two or more polyisocyanate compounds.

Examples of preferable triisocyanates include an isocyanurate product of hexamethylene diisocyanate, a biuret product of hexamethylene diisocyanate, and an isocyanurate product of isophorone diisocyanate.

Preferably, the polyisocyanate composition (B) contains a triisocyanate. The proportion of the triisocyanate to the entire polyisocyanate compound in the polyisocyanate composition (B) is preferably not less than 50% by weight, more preferably not less than 60% by weight, and particularly preferably not less than 70% by weight. The polyisocyanate composition (B) may contain only the triisocyanate as the polyisocyanate compound.

The isocyanate group amount (NCO %) of the polyisocyanate compound contained in the polyisocyanate composition (B) is preferably not less than 0.5% by weight, more preferably not less than 1.0% by weight, and particularly preferably not less than 2.0% by weight. The isocyanate group amount is preferably not greater than 45% by weight, more preferably not greater than 40% by weight, and particularly preferably not greater than 35% by weight. The isocyanate group amount (NCO %) is calculated by the following mathematical formula.

NCO=(100×Mi×42)/Wi

Mi: the number of moles of the isocyanate groups in the polyisocyanate compound

42: the molecular weight of NCO

Wi: the total weight (g) of the polyisocyanate compound

Specific examples of the polyisocyanate compound include: trade names “BURNOCK D-800”, “BURNOCK DN-950”, “BURNOCK DN-955”, manufactured by DIC corporation; trade names “Desmodur N 75 MPA/X”, “Desmodur N 3300”, “Desmodur L 75 (C)”, and “Sumidur E21-1”, manufactured by Sumika Bayer Urethane CO., Ltd.; trade names “CORONATE HX” and “CORONATE HK”, manufactured by Tosoh Corporation; trade names “DURANATE 24A-100”, “DURANATE 21S-75E”, “DURANATE TPA-100”, and “DURANATE TKA-100”, manufactured by Asahi Kasei Chemicals Corporation; and trade name “VESTANAT T1890” manufactured by Degussa AG.

In the polyurethane paint forming the paint layer 6, the mole ratio (NCO/OH) of the hydroxyl group (OH group) of the base material and the isocyanate group (NCO group) of the curing agent is preferably not less than 0.10. With the polyurethane paint in which this mole ratio is not less than 0.10, the paint layer 6 having excellent stain resistance can be formed. From this viewpoint, this mole ratio is particularly preferably not less than 0.20. In light of spin performance of the golf ball 2, the mole ratio (NCO/OH) is preferably not greater than 2.0, more preferably not greater than 1.80, and particularly preferably not greater than 1.60.

Polyisocyanate compounds suitable for the polyol composition (A) of Embodiment 1 described above are a biuret-modified product of hexamethylene diisocyanate, an isocyanurate-modified product of hexamethylene diisocyanate, and an isocyanurate-modified product of isophorone diisocyanate. A biuret-modified product of hexamethylene diisocyanate and an isocyanurate-modified product of hexamethylene diisocyanate may be used in combination. In this case, the weight ratio of the biuret-modified product and the isocyanurate-modified product is preferably not less than 20/40 and not greater than 40/20, and particularly preferably not less than 25/35 and not greater than 35/25.

A polyisocyanate compound suitable for the polyol composition (A) of Embodiment 2 described above is an isocyanurate-modified product of hexamethylene diisocyanate.

In this embodiment, the inner layer 14 is formed by applying a first paint to the outer surface of the cover 12 of the golf ball 2 and drying the first paint. The drying temperature is preferably not lower than 30° C. and not higher than 70° C. The drying time is preferably not shorter than 1 hour and not longer than 24 hours.

In the golf ball 2, the outer layer 16 is formed by applying a second paint to the outer surface of the inner layer 14 and drying the second paint. The drying temperature is preferably not lower than 30° C. and not higher than 70° C. The drying time is preferably not shorter than 1 hour and not longer than 24 hours.

The paint layer 6 in which the indentation depth Di is lower than the indentation depth Do can be obtained by using a first paint having a high mole ratio (NCO/OH) for the inner layer 14 and using a second paint having a low mole ratio (NCO/OH) for the outer layer 16. From this viewpoint, the mole ratio (NCO/OH) of the first paint forming the inner layer 14 is preferably not less than 0.50 and more preferably not less than 0.70. From the same viewpoint, the mole ratio (NCO/OH) of the second paint forming the outer layer 16 is preferably not greater than 1.50 and more preferably not greater than 1.30.

The paint layer 6 in which the indentation depth Di is lower than the indentation depth Do can be obtained by using a first paint including a polyol compound having a low molecular weight for the inner layer 14 and using a second paint including a polyol compound having a high molecular weight for the outer layer 16.

### Second Embodiment

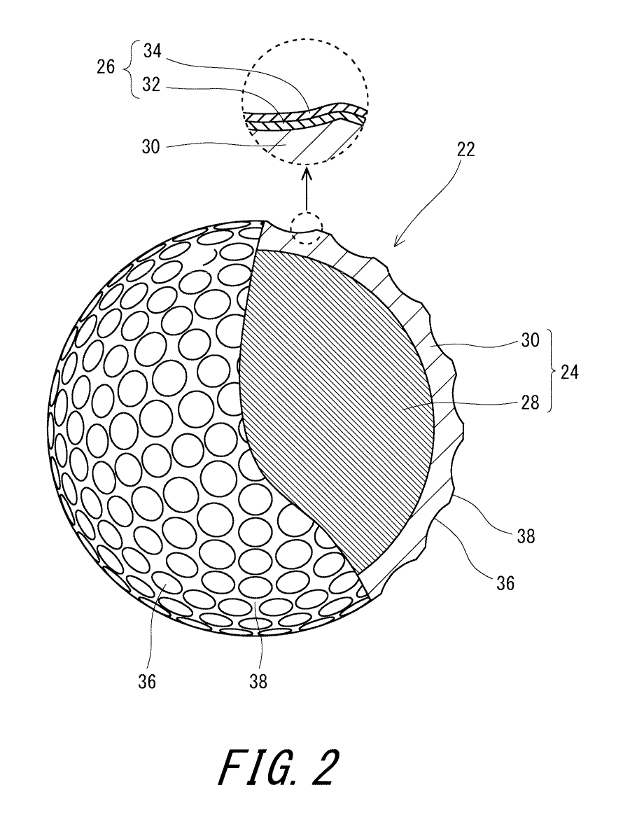

A golf ball 22 shown in FIG. 2 includes a main body 24 and a paint layer 26 positioned outside the main body 24. The main body 24 includes a spherical core 28 and a cover 30 positioned outside the core 28. The paint layer 26 includes an inner layer 32 positioned outside the cover 30, and an outer layer 34 positioned outside the inner layer 32. The golf ball 22 has a plurality of dimples 36 on the surface thereof. Of the surface of the golf ball 22, a part other than the dimples 36 is a land 38. The golf ball 22 may include a mark layer. The mark layer may be positioned between the cover 30 and the paint layer 26, or may be positioned outside the paint layer 26. The mark layer may be positioned between the inner layer 32 and the outer layer 34. The paint layer 26 can further include another layer between the inner layer 32 and the outer layer 34.

The golf ball 22 preferably has a diameter of not less than 40 mm and not greater than 45 mm. From the viewpoint of conformity to the rules established by the United States Golf Association (USGA), the diameter is particularly preferably not less than 42.67 mm. In light of suppression of air resistance, the diameter is more preferably not greater than 44 mm and particularly preferably not greater than 42.80 mm. The golf ball 22 preferably has a weight of not less than 40 g and not greater than 50 g. In light of attainment of great inertia, the weight is more preferably not less than 44 g and particularly preferably not less than 45.00 g. From the viewpoint of conformity to the rules established by the USGA, the weight is particularly preferably not greater than 45.93 g.

The golf ball 22 preferably has an amount of compressive deformation Sb of not less than 1.80 mm and not greater than 3.30 mm. The method for measuring the amount of compressive deformation Sb will be described later.

The core 28 is formed by crosslinking a rubber composition. For the core 28, a rubber composition that is the same as the rubber composition of the core 8 described above in the first embodiment can be used. In light of resilience performance, the core 28 has a diameter of preferably not less than 30.0 mm and particularly preferably not less than 38.0 mm. In light of spin performance, the diameter of the core 28 is preferably not greater than 42.0 mm and particularly preferably not greater than 41.5 mm.

The core 28 preferably has an amount of compressive deformation Sc of not less than 2.5 mm and not greater than 3.9 mm. The method for measuring the amount of compressive deformation Sc will be described later.

The core 28 preferably has a hardness Ho of not less than 40 and not greater than 75, and preferably has a hardness Hs of not less than 60 and not greater than 95. The hardness difference (Hs−Ho) is preferably not less than 10 and not greater than 45. The hardness Ho and the hardness Hs of the core 28 are measured by the same methods as described above for the core 8 in the first embodiment.

In the golf ball 22, the cover 30 is formed outside the core 28. The cover 30 may include two or more layers.

The cover 30 is formed from a resin composition. For the cover 30, a resin composition that is the same as the resin composition of the mid layer 10 described above in the first embodiment can be used. A preferable base polymer of the resin composition is an ionomer resin.

Instead of an ionomer resin or together with an ionomer resin, the resin composition of the cover 30 may include another polymer. Examples of the other polymer include polystyrenes, polyamides, polyesters, polyolefins, and polyurethanes. The resin composition may include two or more polymers.

In the golf ball 22, the cover 30 preferably has a Shore D hardness Hc of not less than 50 and not greater than 80. The golf ball 22 that includes the cover 30 having a hardness Hc of not less than 50 has excellent stain resistance. From this viewpoint, the hardness Hc of the cover 30 is more preferably not less than 52 and particularly preferably not less than 54. The cover 30 having a hardness Hc of not greater than 80 contributes to a high spin rate and feel at impact upon an approach shot. From this viewpoint, the hardness Hc of the cover 30 is more preferably not greater than 78 and particularly preferably not greater than 76. In the case where the cover 30 includes two or more layers, the hardness of each layer forming the cover 30 preferably satisfies this numerical range. The hardness Hc of the cover 30 is measured by the same method as described above for the cover 12 in the first embodiment.

In the golf ball 22, the cover 30 preferably has a thickness Tc of not less than 0.5 mm and not greater than 3.0 mm. The cover 30 having a thickness Tc of not less than 0.5 mm can contribute to spin performance. From this viewpoint, the thickness Tc of the cover 30 is more preferably not less than 0.8 mm and particularly preferably not less than 1.0 mm. The cover 30 having a thickness Tc of not greater than 3.0 mm can contribute to feel at impact. From this viewpoint, the thickness Tc of the cover 30 is more preferably not greater than 2.7 mm and particularly preferably not greater than 2.5 mm. In the case where the cover 30 includes two or more layers, the total thickness of all the layers forming the cover 30 preferably satisfies this numerical range. The thickness Tc of the cover 30 is measured at a position immediately below the land 38.

In the golf ball 22, the paint layer 26 is formed outside the cover 30. As shown, the paint layer 26 includes the inner layer 32 and the outer layer 34. In the present invention, an indentation depth Di of the inner layer 32 and an indentation depth Do of the outer layer 34 are measured by the same method as described above for the inner layer 14 and the outer layer 16 in the first embodiment.

In another embodiment, in the case where the paint layer 26 includes three or more layers, the layer that is closest to the cover 30 is referred to as innermost layer, and the layer that is furthest from the cover 30 is referred to as outermost layer. In this embodiment, an indentation depth of the innermost layer of the paint layer 26 is measured as Di, and an indentation depth of the outermost layer of the paint layer 26 is measured as Do.

In the present invention, the indentation depth Di of the inner layer 32 is lower than the indentation depth Do of the outer layer 34. In other words, the inner layer 32 is harder than the outer layer 34. The hard inner layer 32 contributes to a high spin rate in a wet state. In the golf ball 22, controllability upon an approach shot in a wet state is improved by the inner layer 32 having a low indentation depth Di. Meanwhile, the outer layer 34 is flexible as compared to the inner layer 32. The flexible outer layer 34 contributes to a high spin rate in a dry state. The golf ball 22 including the outer layer 34 has excellent controllability upon an approach shot in a dry state.

In light of stain resistance and controllability in a wet state, the indentation depth Di of the inner layer 32 is preferably less than 1000 nm, more preferably not greater than 900 nm, and particularly preferably not greater than 800 nm. In light of feel at impact and controllability in a dry state, the indentation depth Di of the inner layer 32 is preferably not less than 100 nm, more preferably not less than 200 nm, and particularly preferably not less than 300 nm.

In light of feel at impact and controllability in a dry state, the indentation depth Do of the outer layer 34 is preferably not less than 1000 nm, more preferably not less than 1100 nm, and particularly preferably not less than 1200 nm. In light of stain resistance and controllability in a wet state, the indentation depth Do of the outer layer 34 is preferably not greater than 3000 nm, more preferably not greater than 2900 nm, and particularly preferably not greater than 2800 nm.

In light of achievement of desired controllability both in a wet state and in a dry state, the difference (Do-Di) between the indentation depth Do of the outer layer 34 and the indentation depth Di of the inner layer 32 is preferably not less than 50 nm, more preferably not less than 70 nm, and further preferably not less than 90 nm. In light of durability of the paint layer 26, the difference (Do−Di) is preferably not greater than 1800 nm, more preferably not greater than 1700 nm, and further preferably not greater than 1600 nm.

As described above, in the golf ball 22, the cover 30 contributes to spin performance upon an approach shot. In light of the synergetic effect with the cover 30 having a hardness Hc of not less than 50 and not greater than 80, the difference (Do−Di) is more preferably not less than 50 nm and not greater than 1000 nm. In the golf ball 22 that includes the cover 30 having a hardness Hc of not less than 50 and not greater than 80 and the paint layer 26 having a difference (Do−Di) of not less than 50 nm and not greater than 1000 nm, controllability both in a wet state and in a dry state is achieved at a high level.

In light of spin performance upon an approach shot, the inner layer 32 has a thickness Ti of preferably not less than 5 μm, more preferably not less than 6 μm, and particularly preferably not less than 7 μm. From the same viewpoint, the thickness Ti of the inner layer 32 is preferably not greater than 50 μm, more preferably not greater than 40 μm, and particularly preferably not greater than 30 μm.

In light of spin performance upon an approach shot, the outer layer 34 has a thickness To of preferably not less than 5 μm, more preferably not less than 6 μm, and particularly preferably not less than 7 μm. From the same viewpoint, the thickness To of the outer layer 34 is preferably not greater than 50 μm, more preferably not greater than 40 μm, and particularly preferably not greater than 30 μm.

The sum (Ti+To) of the thickness Ti of the inner layer 32 and the thickness To of the outer layer 34 is preferably not less than 10 μm and not greater than 100 μm. In the case where the paint layer 26 includes another layer between the inner layer 32 and the outer layer 34, the total thickness of all the layers forming the paint layer 26 is set to be not less than 10 μm and not greater than 100 μm. In light of controllability in a dry state and in a wet state, this total thickness is more preferably not less than 12 μm and particularly preferably not less than 14 μm. From the viewpoint that the effect achieved by the cover 30 is not impaired, the total thickness is more preferably not greater than 80 μm and particularly preferably not greater than 60 μm.

In light of controllability in a dry state, the ratio (To/Ti) of the thickness To of the outer layer 34 relative to the thickness Ti of the inner layer 32 is preferably not less than 0.2, more preferably not less than 0.3, and particularly preferably not less than 0.4. In light of controllability in a wet state, the ratio (To/Ti) is preferably not greater than 5, more preferably not greater than 4, and particularly preferably not greater than 3.

The inner layer 32 is formed from a resin composition. For the inner layer 32, a resin composition that is the same as the resin composition of the inner layer 14 described above in the first embodiment can be used. In this embodiment, the inner layer 32 is formed by applying a first paint to the outer surface of the cover 30 of the golf ball 22 and drying the first paint.

The outer layer 34 is formed from a resin composition. For the outer layer 34, a resin composition that is the same as the resin composition of the outer layer 16 described above in the first embodiment can be used. In the golf ball 22, the outer layer 34 is formed by applying a second paint to the outer surface of the inner layer 32 and drying the second paint.

### EXAMPLES

The following will show the effects of the present invention by means of Examples, but the present invention should not be construed in a limited manner on the basis of the description of these Examples.

### Example 1

A rubber composition was obtained by kneading 100 parts by weight of a high-cis polybutadiene (trade name “BR-730”, manufactured by JSR Corporation), 23.5 parts by weight of zinc diacrylate (trade name “Sanceler SR”, manufactured by SANSHIN CHEMICAL INDUSTRY CO., LTD.), 5 parts by weight of zinc oxide (trade name “Ginrei R”, manufactured by Toho Zinc Co., Ltd.), an appropriate amount of barium sulfate (trade name “Barium Sulfate BD”, manufactured by Sakai Chemical Industry Co., Ltd.), and 0.95 parts by weight of dicumyl peroxide (trade name “Percumyl D”, manufactured by NOF Corporation). This rubber composition was placed into a mold including upper and lower mold halves each having a hemispherical cavity, and heated at 155° C. for 18 minutes to obtain a core S1 with a diameter of 38.7 mm. The amount of barium sulfate was adjusted such that a core having a predetermined weight was obtained. The details of the obtained core S1 are shown in Table 1 below.

A resin composition a was obtained by kneading 55 parts by weight of an ionomer resin (trade name “Himilan AM7329”, manufactured by Du Pont-MITSUI POLYCHEMICALS Co., Ltd.), 45 parts by weight of another ionomer resin (trade name “Himilan 1555”, manufactured by Du Pont-MITSUI POLYCHEMICALS Co., Ltd.), an appropriate amount of barium sulfate, and 3 parts by weight of titanium dioxide with a twin-screw kneading extruder. Half shells were obtained from the resin composition a by compression molding. The core S1 was covered with two of the half shells. These half shells and the core S1 were placed into a final mold that includes upper and lower mold halves each having a hemispherical cavity and having a large number of pimples on its cavity face, and a cover with a thickness of 2.0 mm was obtained by compression molding. Dimples having a shape that is the inverted shape of the pimples were formed on the cover.

Polytetramethylene ether glycol (PTMG, number average molecular weight: 650) and trimethylol propane (TMP) were dissolved in a solvent (toluene and methyl ethyl ketone). The mole ratio (PTMG:TMP) was 1.8:1.0. Dibutyltin dilaurate was added to this solution as a catalyst in an amount of 0.1% by weight with respect to the entire base material. While this polyol solution was kept at 80° C., isophorone diisocyanate (IPDI) was dropped and mixed into the polyol solution. The mole ratio (NCO/OH) of this mixture solution was 0.6. After the dropping, the mixture solution was continuously agitated until the isocyanate component in the mixture solution was eliminated. Thereafter, the mixture solution was cooled at normal temperature to obtain a urethane polyol that is a base material (polyol composition (A)). The details of this base material are as follows.

Solid content: 30% by weight

Content of PTMG: 67% by weight

Hydroxyl value of solid content: 67.4 mg KOH/g

Weight average molecular weight of urethane polyol: 4867

Mixed were 30 parts by weight of an isocyanurate-modified product of hexamethylene diisocyanate (trade name “DURANATE TKA-100”, manufactured by Asahi Kasei Chemicals Corporation, NCO content: 21.7% by weight), 30 parts by weight of a biuret-modified product of hexamethylene diisocyanate (trade name “DURANATE 21S-75E”, manufactured by Asahi Kasei Chemicals Corporation, NCO content: 15.5% by weight), and 40 parts by weight of an isocyanurate-modified product of isophorone diisocyanate (trade name “Desmodur Z 4470”, manufactured by Sumika Bayer Urethane CO., Ltd., NCO content: 11.9% by weight). A mixed solvent of methyl ethyl ketone, n-butyl acetate, and toluene was added as a solvent to this mixture to obtain a polyisocyanate composition (B) that is a curing agent. The concentration of the polyisocyanate compound in this curing agent was 60% by weight.

A first paint was obtained by mixing the aforementioned base material (polyol composition (A)) and the aforementioned curing agent (polyisocyanate composition (B)). The mixing ratio (A/B) of the first paint on the solid content basis was 3.06/1 (weight ratio), and the mole ratio (NCO/OH) of the first paint was 1.03. The surface of a main body consisting of the aforementioned core and the aforementioned cover was treated with sandblast, and the first paint was applied to the cover and dried at 40° C. for 24 hours to obtain an inner layer with a thickness of 10 μm.

A second paint was obtained by mixing the aforementioned base material and the aforementioned curing agent. The mixing ratio (A/B) of the second paint on the solid content basis was 6.8/1 (weight ratio), and the mole ratio (NCO/OH) of the second paint was 0.46. The second paint was applied to the inner layer and dried at 40° C. for 24 hours to obtain an outer layer with a thickness of 10 μm. The diameter of a golf ball including this outer layer was about 42.7 mm, and the weight thereof was about 45.6 g.

### Examples 2 and 3 and Comparative Examples 1 to 3

Golf balls of Examples 2 and 3 and Comparative Examples 1 to 3 were obtained in the same manner as Example 1, except the mixing ratio (A/B) of the aforementioned base material and the aforementioned curing agent was as shown in Table 3 below.

### Example 4

A golf ball of Example 4 was obtained in the same manner as Example 1, except the composition of the cover and the mixing ratios (A/B) of the first paint and the second paint were as shown in Table 3 below. The composition of the cover was shown in detail in Table 2 below.

### Example 5

A rubber composition was obtained by kneading 100 parts by weight of a high-cis polybutadiene (trade name “BR-730”, manufactured by JSR Corporation), 30.5 parts by weight of zinc diacrylate (trade name “Sanceler SR”, manufactured by SANSHIN CHEMICAL INDUSTRY CO., LTD.), 10 parts by weight of zinc oxide (trade name “Ginrei R”, manufactured by Toho Zinc Co., Ltd.), an appropriate amount of barium sulfate (trade name “Barium Sulfate BD”, manufactured by Sakai Chemical Industry Co., Ltd.), 0.1 parts by weight of 2-thionaphthol (manufactured by Tokyo Chemical Industry Co., Ltd.), 0.3 parts by weight of bis(pentabromophenyl)disulfide (PBPS) (manufactured by Kawaguchi Chemical Industry Co., Ltd.), 0.7 parts by weight of dicumyl peroxide (trade name “Percumyl D”, manufactured by NOF Corporation), and 2 parts by weight of benzoic acid (manufactured by Tokyo Chemical Industry Co., Ltd.). This rubber composition was placed into a mold including upper and lower mold halves each having a hemispherical cavity, and heated at 150° C. for 19 minutes to obtain a core S2 with a diameter of 39.7 mm. The amount of barium sulfate was adjusted such that a core having a predetermined weight was obtained.

A resin composition a was obtained by kneading 55 parts by weight of an ionomer resin (trade name “Himilan AM7329”, manufactured by Du Pont-MITSUI POLYCHEMICALS Co., Ltd.), 45 parts by weight of another ionomer resin (trade name “Himilan 1555”, manufactured by Du Pont-MITSUI POLYCHEMICALS Co., Ltd.), an appropriate amount of barium sulfate, and 3 parts by weight of titanium dioxide with a twin-screw kneading extruder. The core S2 was covered with the resin composition a by injection molding to form a mid layer with a thickness of 1.0 mm.

A paint composition (trade name “POLIN 750LE”, manufactured by SHINTO PAINT CO., LTD.) including a two-component curing type epoxy resin as a base polymer was prepared. The base material liquid of this paint composition includes 30 parts by weight of a bisphenol A type epoxy resin and 70 parts by weight of a solvent. The curing agent liquid of this paint composition includes 40 parts by weight of a modified polyamide amine, 55 parts by weight of a solvent, and 5 parts by weight of titanium dioxide. The weight ratio of the base material liquid to the curing agent liquid is 1/1. This paint composition was applied to the surface of the mid layer with a spray gun, and kept at 23° C. for 12 hours to obtain a reinforcing layer with a thickness of 10 μm.

A resin composition b was obtained by kneading 100 parts by weight of a thermoplastic polyurethane elastomer (trade name “Elastollan NY80A”, manufactured by BASF Japan Ltd.), 4 parts by weight titanium dioxide, and 0.04 parts by weight of ultramarine blue with a twin-screw kneading extruder. Half shells were obtained from this resin composition b by compression molding. The sphere consisting of the core S2, the mid layer, and the reinforcing layer was covered with two of these half shells. These half shells and the sphere were placed into a final mold that includes upper and lower mold halves each having a hemispherical cavity and having a large number of pimples on its cavity face, and a cover was obtained by compression molding. The thickness of the cover was 0.5 mm. Dimples having a shape that is the inverted shape of the pimples were formed on the cover.

A first paint (the weight ratio (A/B) on the solid content basis=3.06/1, the mole ratio (NCO/OH)=1.03) was obtained by mixing the base material and the curing agent described above in Example 1. The surface of a main body consisting of the aforementioned core S2, the aforementioned mid layer, the aforementioned reinforcing layer, and the aforementioned cover was treaded with sandblast, and the first paint was applied to the cover and dried at 40° C. for 24 hours to obtain an inner layer with a thickness of 10 μm.

A second paint (the weight ratio (A/B) on the solid content basis=6.8/1, the mole ratio (NCO/OH)=0.46) was obtained by mixing the base material and the curing agent described above in Example 1. The second paint was applied to the inner layer and dried at 40° C. for 24 hours to obtain an outer layer with a thickness of 10 μm. The diameter of a golf ball including this outer layer was about 42.7 mm, and the weight thereof was about 45.6 g.

### Examples 6 to 8 and Comparative Examples 4 to 6

Golf balls of Examples 6 to 8 and Comparative Examples 4 to 6 were obtained in the same manner as Example 5, except the mixing ratio (A/B) of the base material and the curing agent described above in Example 1 was as shown in

Tables 4 and 5 below.

### Example 9

A golf ball of Example 9 was obtained in the same manner as Example 5, except the composition of the cover and the mixing ratios (A/B) of the first paint and the second paint were as shown in Table 4 below. The composition of the cover was shown in detail in Table 2 below.

[Amount of Compressive Deformation]

The amounts of compressive deformation of a core and a golf ball were measured with a YAMADA type compression tester. In the tester, a sphere to be measured (the core or the golf ball) was placed on a hard plate made of metal. Next, a cylinder made of metal gradually descended toward the sphere. The sphere, squeezed between the bottom face of the cylinder and the hard plate, became deformed. A migration distance (mm) of the cylinder, starting from the state in which an initial load of 98 N was applied to the sphere up to the state in which a final load of 1274 N was applied thereto, was measured. A moving speed of the cylinder until the initial load was applied was 0.83 mm/s. A moving speed of the cylinder after the initial load was applied until the final load was applied was 1.67 mm/s. The obtained amount of compressive deformation of the core is shown as Sc in Table 1 below. The obtained amount of compressive deformation of the golf ball is shown as Sb in Tables 3 to 5 below.

[Spin Rate (SW)]

A sand wedge (trade name “CG15 Forged Wedge”, manufactured by Cleveland Golf Company, loft angle: 52°) was attached to a swing machine manufactured by Golf Laboratories, Inc. A golf ball was hit under a condition of a head speed of 16 m/s, and the backspin rate Rd (rpm) under a dry condition was measured. The backspin rate Rw (rpm) under a wet condition was measured by conducting the same test in a state where water was adhered to the face of the sand wedge and the golf ball. The average value of data obtained by 10 times of each measurement is shown in Tables 3 to 5 below.

[Feel at Impact]

Thirty golf players hit golf balls with sand wedges (trade name “CG15 Forged Wedge”, manufactured by Cleveland Golf Company, Inc., loft angle: 52°) and were asked about feel at impact. The evaluation was categorized as follows on the basis of the number of golf players who answered, “the feel at impact was good”.

A: 25 persons or more

B: 20 to 24 persons

C: 15 to 19 persons

D: 14 persons or less

The results are shown in Tables 3 to 5 below.

[Stain Resistance]

The color tone (L, a, b) of the surface of a golf ball was measured with a color difference meter (“CM3500D” manufactured by KONICA MINOLTA, INC.). An ethanol solution including 6% by weight of iodine and 4% by weight of potassium iodide (that is, iodine tincture) was prepared. The iodine tincture was diluted with water to 40-fold. The golf ball was immersed in the diluted solution for 30 seconds. The diluted solution adhering to the surface of the golf ball taken out from the diluted solution was wiped off. The color tone of the golf ball was measured again. A color difference ΔE was calculated on the basis of the following mathematical formula.

ΔE=(ΔL²+Δa²+Δb²)^{1/2}

The evaluation was categorized as follows on the basis of the color difference ΔE.

A: ΔE is equal to or less than 15.

B: ΔE exceeds 15 and is equal to or less than 20.

C: ΔE exceeds 20 and is equal to or less than 25.

D: ΔE exceeds 25

The results are shown in Tables 3 to 5 below.

TABLE 1
Type of Core

| Type | S1 | S2 |
|---|---|---|
| Composition | | |
| (parts by weight) | | |
| Polybutadiene | 100 | 100 |
| Zinc diacrylate | 23.5 | 30.5 |
| Zinc oxide | 5 | 10 |
| Barium sulfate | * | * |
| 2-thionaphthol | — | 0.1 |
| PBPS | — | 0.3 |
| Dicumyl peroxide | 0.95 | 0.7 |
| Benzoic acid | — | 2 |
| Vulcanization | | |
| conditions | | |
| Temperature (° C.) | 155 | 150 |
| Time (min) | 18 | 19 |
| Composition | | |
| Diameter (mm) | 38.7 | 39.7 |
| Sc (mm) | 3.5 | 3.3 |
| Ho (shore C) | 64 | 53 |
| Hs (shore C) | 80 | 80 |
| Hs − Ho | 16 | 27 |

* Appropriate amount

TABLE 2
Compositions of Mid Layer and Cover

(parts by weight)

| Type | a | b | c | d |
|---|---|---|---|---|
| Himilan AM7329 | 55 | — | — | — |
| Himilan 1555 | 45 | — | — | 47 |
| Himilan 1557 | — | — | — | 46 |
| RABALON T3221C | — | — | — | 7 |
| Elastollan NY80A | — | 100 | — | — |
| Elastollan NY97A | — | — | 100 | — |
| Barium sulfate | * | — | — | — |
| Titanium dioxide | 3 | 4 | 4 | 4 |
| Ultramarine blue | — | 0.04 | 0.04 | 0.08 |
| Material hardness | 62 | 27 | 47 | 57 |
| (shore D) | | | | |

* Appropriate amount

TABLE 3
Results of Evaluation

| | | | | | Comp. | Comp. | Comp. |
|---|---|---|---|---|---|---|---|
| | Ex. 1 | Ex. 2 | Ex. 3 | Ex. 4 | Ex. 1 | Ex. 2 | Ex. 3 |
| Core | S1 | S1 | S1 | S1 | S1 | S1 | S1 |
| Mid layer | | | | | | | |
| Composition | — | — | — | — | — | — | — |
| Hm(Shore D) | — | — | — | — | — | — | — |
| Tm (mm) | — | — | — | — | — | — | — |
| Cover | | | | | | | |
| Composition | a | a | a | c | a | a | a |
| Hc(Shore D) | 62 | 62 | 62 | 47 | 62 | 62 | 62 |
| Tc (mm) | 2.0 | 2.0 | 2.0 | 2.0 | 2.0 | 2.0 | 2.0 |
| Paint Inner | | | | | | | |
| A/B (wt) | 3.06/1 | 2.6/1 | 3.06/1 | 2.6/1 | 6.8/1 | 6.8/1 | 3.06/1 |
| NCO/OH(mol) | 1.03 | 1.21 | 1.03 | 1.21 | 0.46 | 0.46 | 1.03 |
| Di (nm) | 390 | 290 | 390 | 290 | 1500 | 1500 | 390 |
| Ti (μm) | 10 | 10 | 10 | 10 | 10 | 10 | 10 |
| Paint Outer | | | | | | | |
| A/B (wt) | 6.8/1 | 20/1 | 6.4/1 | 20/1 | 3.06/1 | 6.8/1 | 3.06/1 |
| NCO/OH(mol) | 0.46 | 0.16 | 0.49 | 0.16 | 1.03 | 0.46 | 1.03 |
| Do (nm) | 1500 | 3400 | 1250 | 3400 | 390 | 1500 | 390 |
| To (μm) | 10 | 10 | 10 | 10 | 10 | 10 | 10 |
| Do − Di (nm) | 1110 | 3110 | 860 | 3110 | −1110 | 0 | 0 |
| Sb (mm) | 2.8 | 2.8 | 2.8 | 3.0 | 2.8 | 2.8 | 2.8 |
| SW spin rate | | | | | | | |
| Dry Rd(rpm) | 3950 | 4050 | 3900 | 5000 | 3800 | 4050 | 3700 |
| Wet Rw(rpm) | 1900 | 2000 | 1800 | 3500 | 1800 | 1600 | 2100 |
| Feeling | B | A | B | A | C | A | C |
| Stain Resist. | A | B | A | B | A | C | A |

TABLE 4
Results of Evaluation

| | Ex. 5 | Ex. 6 | Ex. 7 | Ex. 8 | Ex. 9 |
|---|---|---|---|---|---|
| Core | S2 | S2 | S2 | S2 | S2 |
| Mid layer | | | | | |
| Composition | a | a | a | a | a |
| Hm(Shore D) | 62 | 62 | 62 | 62 | 62 |
| Tm (mm) | 1.0 | 1.0 | 1.0 | 1.0 | 1.0 |
| Cover | | | | | |
| Composition | b | c | b | b | d |
| Hc(Shore D) | 27 | 47 | 27 | 27 | 57 |
| Tc (mm) | 0.5 | 0.5 | 0.5 | 0.5 | 0.5 |
| Paint Inner | | | | | |
| A/B (wt) | 3.06/1 | 3.06/1 | 2.6/1 | 3.06/1 | 2.6/1 |
| NCO/OH(mol) | 1.03 | 1.03 | 1.21 | 1.03 | 1.21 |
| Di (nm) | 390 | 390 | 290 | 390 | 290 |
| Ti (μm) | 10 | 10 | 10 | 10 | 10 |
| Paint Outer | | | | | |
| A/B (wt) | 6.8/1 | 6.8/1 | 20/1 | 6.4/1 | 20/1 |
| NCO/OH(mol) | 0.46 | 0.46 | 0.16 | 0.49 | 0.16 |
| Do (nm) | 1500 | 1500 | 3400 | 1250 | 3400 |
| To (μm) | 10 | 10 | 10 | 10 | 10 |
| Do − Di (nm) | 1110 | 1110 | 3110 | 860 | 3110 |
| Sb (mm) | 2.9 | 2.9 | 2.9 | 2.9 | 2.8 |
| SW spin rate | | | | | |
| Dry Rd(rpm) | 4700 | 4300 | 4800 | 4650 | 3900 |
| Wet Rw(rpm) | 2800 | 2600 | 2900 | 2700 | 1900 |
| Feeling | B | B | A | B | B |
| Stain Resist. | A | B | B | A | B |

TABLE 5
Results of Evaluation

| | Comp. | Comp. | Comp. |
|---|---|---|---|
| | Ex. 4 | Ex. 5 | Ex. 6 |
| Core | S2 | S2 | S2 |
| Mid layer | | | |
| Composition | a | a | a |
| Hm(Shore D) | 62 | 62 | 62 |
| Tm (mm) | 1.0 | 1.0 | 1.0 |
| Cover | | | |
| Composition | b | b | b |
| Hc(Shore D) | 27 | 27 | 27 |
| Tc (mm) | 0.5 | 0.5 | 0.5 |
| Paint Inner | | | |
| A/B (wt) | 6.8/1 | 6.8/1 | 3.06/1 |
| NCO/OH(mol) | 0.46 | 0.46 | 1.03 |
| Di (nm) | 1500 | 1500 | 390 |
| Ti (μm) | 10 | 10 | 10 |
| Paint Outer | | | |
| A/B (wt) | 3.06/1 | 6.8/1 | 3.06/1 |
| NCO/OH(mol) | 1.03 | 0.46 | 1.03 |
| Do (nm) | 390 | 1500 | 390 |
| To (μm) | 10 | 10 | 10 |
| Do − Di (nm) | −1110 | 0 | 0 |
| Sb (mm) | 2.8 | 2.8 | 2.8 |
| SW spin rate | | | |
| Dry Rd(rpm) | 4550 | 4800 | 4450 |
| Wet Rw(rpm) | 2700 | 2500 | 3000 |
| Feeling | C | A | C |
| Stain Resist. | A | C | A |

As shown in Tables 3 to 5, the golf ball of each Example is excellent in various performance characteristics. From the results of evaluation, advantages of the present invention are clear.

The paint layer described above is applicable to a one-piece ball, a four-piece ball, a five-piece ball, a six-piece ball, a thread-wound ball, and the like in addition to a two-piece ball and a three-piece ball. The golf ball according to the present invention is suitable for, for example, playing golf on golf courses and practicing at driving ranges. The above descriptions are merely illustrative examples, and various modifications can be made without departing from the principles of the present invention.

What is claimed is:

1. A golf ball comprising a main body and a paint layer positioned outside the main body, wherein
the paint layer includes an inner layer and an outer layer positioned outside the inner layer,
when an indentation depth (mm) is measured on a cross-section along a plane passing through a central point of the golf ball when a force of 30 mgf is applied to the cross-section in a direction perpendicular to the cross-section, an indentation depth Di on a cross section of the inner layer is lower than an indentation depth Do on a cross-section of the outer layer.

2. The golf ball according to claim 1, wherein the indentation depth Di is less than 1000 nm.

3. The golf ball according to claim 1, wherein the indentation depth Do is not less than 1000 nm.

4. The golf ball according to claim 1, wherein a difference (Do−Di) between the indentation depth Do and the indentation depth Di is not less than 50 nm and not greater than 1800 nm.

5. The golf ball according to claim 1, wherein the inner layer has a thickness Ti of not less than 5 μm and not greater than 50 μm, and the outer layer has a thickness To of not less than 5 μm and not greater than 50 μm.

6. The golf ball according to claim 1, wherein
the main body includes a core and a cover positioned outside the core,
the paint layer is laminated on the cover, and
the cover has a Shore D hardness Hc of not less than 50 and not greater than 80.

7. The golf ball according to claim 6, wherein a difference (Do−Di) between the indentation depth Do and the indentation depth Di is not less than 50 nm and not greater than 1000 nm.

8. The golf ball according to claim 1, wherein
the main body includes a core and a cover positioned outside the core,
the paint layer is laminated on the cover, and
the cover has a Shore D hardness Hc of equal to or greater than 20 and less than 50.

9. The golf ball according to claim 8, wherein a difference (Do−Di) between the indentation depth Do and the indentation depth Di is not less than 200 nm and not greater than 1800 nm.

10. The golf ball according to claim 8, wherein the main body further includes a mid layer between the core and the cover.
